(19) United States
(12) Patent Application Publication
(10) Pub. No.: US 2012/0298436 A1
(43) Pub. Date: Nov. 29, 2012

(54) ENGINE HOOD

(76) Inventor: Kim Ho, Sungnam-shi (KR)

(21) Appl. No.: 13/577,844

(22) PCT Filed: Feb. 9, 2010
(86) PCT No.: PCT/CN10/70589

§ 371 Date: Aug. 8, 2012

(51) Int. Cl. B62D 25/10

(52) U.S. Cl. 180/69.2

(57) ABSTRACT

The present disclosure provides an engine hood for an automobile, comprising: an outer panel; and an inner panel provided below the outer panel and connected to the outer panel, wherein the inner panel is provided with a center element of cell structure in the center portion thereof and an outer frame formed around the center element and disposed in the peripheral portion of the inner panel, each unit cell of the cell structure is bounded by a plurality of wall segments. An automobile comprising the engine hood is also disclosed.

### TECHNICAL FIELD

The present disclosure relates to an engine hood for an automobile.

### BACKGROUND

FIG. 1 depicts an engine hood of conventional design, which comprises an outer panel 1′ and an inner panel 2′ both formed by steel plate. The inner panel 2′ is joined to the outer panel 1′ with the periphery of the inner panel being enveloped by the folded outer rim of the outer panel. Along the folded joints, glue or sealant may be applied to improve joint quality and to avoid corrosion. A plurality of intersecting ridges 3′ are provided in the central portion of the inner panel 2′. Generally, this kind of engine hood is quite heavy, which adds to the difficulty in the operation of opening or closing the engine hood. Particularly, engine hoods that are made of steel cannot exhibit good performance in absorbing impact energy and therefore may entail great injury to the pedestrian.

It is disclosed in the U.S. Pat. No. 7,114,765 B2 an engine hood comprising an outer skin, an inner frame connected to the underside of the outer skin and a foamed metal filling wholly or partly a space defined between the outer skin and the inner frame. The foamed metal basically breaks down upon receiving a certain amount of an external force, so that the energy of collision can be absorbed effectively. However, fragments or particles from the breaking of the foamed metal are likely to fall into the engine room and adversely affect the operation of any auxiliary or engine-related device therein. A modified form of engine hood is also provided, which has a powder receiving member situated below the inner frame of the engine hood for receiving the fragments or particles falling from the foamed metal. Engine hood of this type has disadvantages of high cost and great complexity in manufacturing, and although its weight had dropped significantly as compared with the engine hood wholly made of steel, it is still not so satisfactory in the respect of weight reduction.

U.S. Pat. No. 7,578,548 B2 disclosed another type of engine hood, comprising an outer shell, at least one inner shell disposed below the outer shell and connected to the outer shell, the inner shell having a stiffening region, wherein the stiffening region includes a vaulted structure for ensuring a very homogeneous force level and a homogeneous energy absorption capacity and a greater free deformation movement of the engine hood in the event of a collision. However, this disclosed engine hood still has much room for improvements in weight reduction and simplification in manufacturing.

U.S. Pat. No. 5,706,908 also shows an engine hood provided with an impact absorb member. The impact absorb member can be configured by winding a plate material of roughly rectangular cross section into a coil shape, or by forming upper and lower plates and two side plates into a roughly square cylindrical shape, or by disposing a number of vertical walls between upper and lower plates. All these embodiments of this impact absorb member are likely to deform upon receiving impact of low level, therefore this impact absorb member has a limitation in absorbing impact energy.

The disclosed engine hood is directed to overcoming one or more of the problems set forth above.

### SUMMARY

One object of the present disclosure is to provide an automobile engine hood that is of low weight and high energy-absorption capacity and may be manufactured easily and cost-effectively.

According to the invention, an engine hood for an automobile, comprises: an outer panel; and an inner panel provided below the outer panel and connected to the outer panel, wherein the inner panel is provided with a center element of cell structure in the center portion thereof and an outer frame formed around the center element and located in the peripheral portion of the inner panel, each unit cell of the cell structure is bounded by a plurality of wall segments.

In the event of head impact against the central region of the engine hood, a large deformation may occur to the center element of cell structure. If the force resulting from the collision exceeds a certain level, the loaded center element may crush immediately, so as to uniformly absorbing the impact energy and not to give too high acceleration peak as well as injury values to the head of the pedestrian.

Advantageously, slits or initial cracks may be preformed on the wall segments.

In one specific embodiment, the wall segments are connected to each other by connecting pieces, so as to ensure connection strength of certain level between the wall segments of each cell unit. Preferably, slits or initial cracks may be preformed in the region where the wall segments are connected to the connecting pieces.

The slits or initial cracks may entail early breaks in event of collision against the center element, so that impact energy can be absorbed effectively to protect the pedestrians colliding against the engine hood.

The center element may be formed integrally with the outer frame, so as to simplify the manufacturing process. Alternatively, the center element is separately formed with respect to the outer frame. This may be favorable for obtaining variety and flexibility in design of the center element.

The inner panel is at least partially made of plastic, so that weight of the engine hood may be reduced. Favorably, the center element is made of plastic. This is because it is easier for plastic to crush in case of collision and energy absorbing capability of plastic is stronger than that of steel or other metal material.

Advantageously, the wall segments are substantially perpendicular to the outer panel. With this configuration, the center element of cell structure can directly absorb the energy from front collision.

Optionally, the unit cells are in rectangular, rhombic or honeycomb-like shape.

In an embodiment, ends of the connecting pieces that are adjacent to the outer panel are configured to be attached to the underside of the outer panel. Advantageously, on the ends of the connecting pieces that are adjacent to the outer panel, flat seating surfaces are provided for application of adhesives thereon so as to attach to the underside of the outer panel. In this configuration, the connection strength between the center element and the outer panel can be strengthened.

The periphery of the outer panel is joined to the outer edge of the outer frame by an insert. Advantageously, the periphery of the outer panel folds downwardly and inwardly to form a recess for holding one end of the insert, and the outer edge of the outer frame is provided with a corresponding recess for holding the other end of the insert.

In an embodiment, a reinforcing member is provided on the outer frame in a region where accessories are to be attached, so as to meet the needs of strength of the engine hood. The reinforcing member can be embodied as a support member extending from the inner panel towards the underside of the outer panel or a metal insert plate embedded in the outer frame of the inner panel. Advantageously, the metal insert plates are bended one or plural times to form steps.

With this invention, weight of the engine hood is considerably reduced and therefore vehicle mass decreases, thereby enhancing car running mileage. Lighter engine hood is easier to lift open and eliminates the need of additional spring elements for assisting in opening the engine hood. Considering the relatively higher cost for spring elements as well as reinforcements needed for attachments of spring elements, additional cost reduction is also expected. In addition, injury to the body or the head of the pedestrian is decreased in the event of collision against the engine hood.

According to another aspect of the invention, an automobile comprising the engine hood is provided.

### BRIEF DESCRIPTION OF THE DRAWINGS

Accompanying drawings which are incorporated in and constitute one part of this specification illustrate examples of preferred embodiments of the present disclosure and, along with the description, serve to explain the principles of the present disclosure, in which

FIG. 1 shows the structure of conventional engine hood;

FIG. 2 schematically shows the structure of the engine hood according to the invention;

FIGS. 3A-3B show two variants of the inner panel of the engine hood according to the invention;

FIGS. 4A-4D are the plan views of the engine hood of the invention, showing variants of the cell structure of the center element in FIG. 2;

FIGS. 5A-5B show the structure of the connecting piece in the unit cell of the center element;

FIGS. 6A-6B show variants of the connecting structure between the wall segments of the unit cell;

FIG. 7A schematically shows the state when the engine hood of conventional type is being impacted; FIG. 7B schematically shows the state when the center element of the inner panel of the engine hood of the invention is being impacted; FIG. 7C shows comparison of acceleration curves of head impacts against engine hoods of conventional type and of the invention;

FIG. 8 shows the plan view of the engine hood of the invention;

FIGS. 9A-9C show the connection structures between the periphery of the outer panel and the periphery of the inner panel in the engine hood of the invention; and

FIGS. 10A-10C show the reinforcements in the outer frame of the inner panel of the engine hood of the invention.

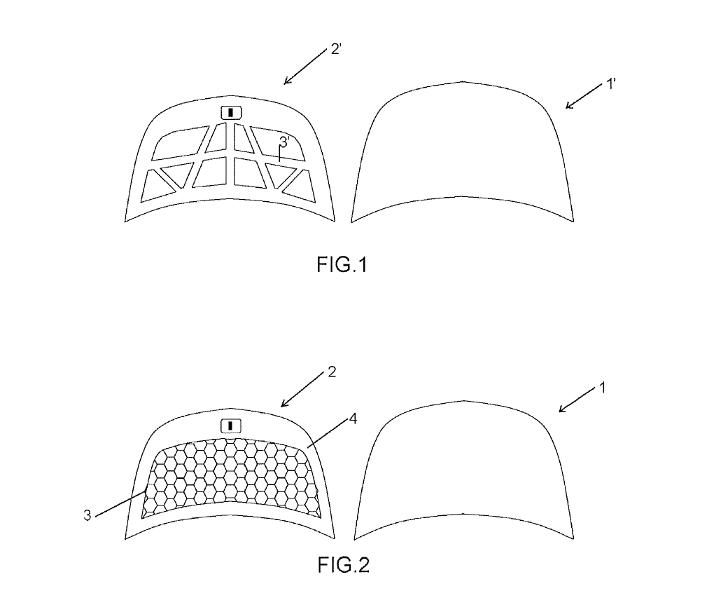

### DETAILED DESCRIPTION OF THE PREFERRED EMBODIMENTS

Preferred embodiments of the present disclosure will be described in details with a reference to accompanying drawings that are included. Like numerals will be used to indicate like components throughout the accompanying drawings, if possible.

Referring to FIG. 2, the engine hood of the invention comprises an outer panel 1 and an inner panel 2, which are connected to each other at the periphery by folding, gluing or any other ways known in the art. The outer panel 1 may be made of steel or plastic. The inner panel 2 is at least partially made of plastic. The inner panel 2 has a centrally located center element 3 and an outer frame 4 that is disposed on the peripheral portion and encircles the center element. The center element 3 may be integrally formed with the outer frame 4 into an integral inner panel 2. It can be envisaged that the center element 3 may be separately formed from plastic by molding process and then attached to the inner edge of the outer frame 4 which is formed separately by metal stamping or plastic molding. Alternatively, the separately formed center element 3 may be connected to the separately formed outer frame 4 by adhesives, mechanical joints or metal connecting pieces.

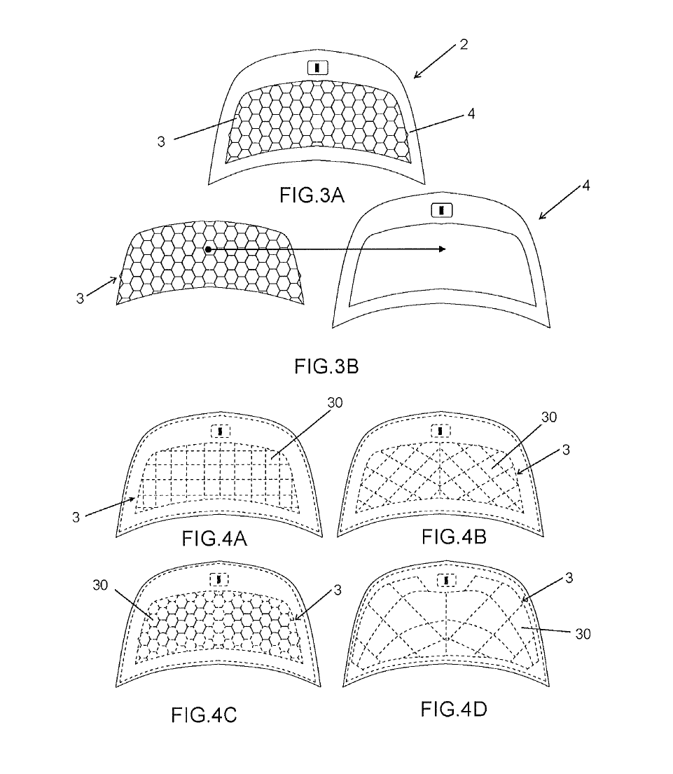

FIG. 3A and FIG. 3B show two different embodiments of the inner panel 2, wherein an integral inner panel is depicted in FIG. 3A, and as shown by the arrow in FIG. 3B, an separately formed center element 3 is attached to a central recess defined by the outer frame 4.

According to the invention, the center element 3 is of cell structure consisting of a plurality of unit cells 30. The unit cell 30 may be present in various shapes. As shown in FIGS. 4A-4D, the unit cell 30 may be rectangular, rhombic, honeycomb-like or free-curved, or in any other shapes. The number of the unit cells may be determined on a case-by-case basis. The whole contour of the center element 3 may vary depending on the shape, number or arrangement of the unit cells 30. Specific structure of the unit cell 30 now will be explained in detail.

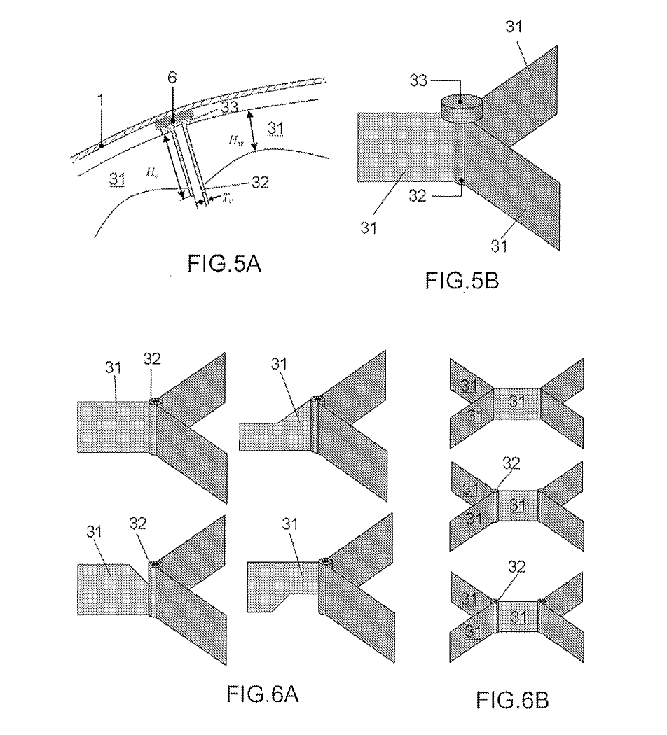

FIG. 5A and FIG. 5B show the preferred structure of the unit cell 30, From FIG. 5A it can be seen that the unit cell 30 is bounded by a plurality of wall segments. The unit cell 30 has a channel-like space encircled by the plurality of wall segments. A connecting piece 32 is provided in the junction region of adjacent wall segments so as to connect the adjacent wall segments to each other. As shown in FIG. 5A and FIG. 5B, the connecting piece 32 is in the form of hollow and cylindrical rod. A circular boss 33 is provided on one end of the connecting piece 32 that is located adjacent to the outer panel 1. The diameter of the boss 33 is larger than that of the connecting piece 32. The boss 33 is provided with a substantially flat seating surface facing the underside of the outer panel. With adhesives applied to the flat seating surface of the boss, the connecting piece 32 may be connected to the underside of the outer panel (see FIG. 5B).

Preferably, the boss 33 is formed integrally with the connecting piece 32. Although it is shown in FIG. 5A that the connecting piece 32 is hollow and cylindrical, the connecting piece 32 may be designed to be solid or have non-circular cross sections, for example, rectangular, rhombic or triangular cross sections. It is shown in FIGS. 5A and 5B that the boss 33 is cylinder-like. However, it is easily conceivable for the skilled person in the art that the boss 33 may be designed to be truncated conical, half-spherical and so on. The boss 33 may also be dispensed with as long as the connecting piece 32 itself is provided with a flat seating surface for attaching to the underside of the outer panel 1 on one of its ends.

Although the wall segments 31 are shown to be substantially perpendicular to the outer panel 1, they may also be configured to incline at a certain angle with respect to the outer panel 1. The skilled person in the art could make any combination or modifications to the opening direction of the unit cell 30 of the center element 3 and the angle formed between the wall segments and the outer panel 1, in accordance with the profile design of the outer panel 1 or particular orientation of shock absorption.

The wall segments 31 and the connecting pieces 32 provided in the junction region of adjacent wall segments 31 may be configured such that the center element 3 has portions designed to be broken upon receiving impact of certain level. This can be realized, for example, by controlling the junction strength between the wall segments and the connecting pieces. Referring to FIG. 6A, slits or initial cracks are pre-formed on certain portions of the wall segments such that the junction strength between the wall segment and the connecting piece is weakened or the strength of the wall segments themselves is weakened. A larger junction area between the wall segment and the connecting piece necessarily leads to a higher junction strength therebetween. By doing so, when the outer panel is hit in the central region, the connecting pieces will transfer the impact force to adjacent wall segments. The weakened or enhanced junction strength between the wall segment and the connecting piece may give early failure or delayed failure to the center element.

Design parameters for controlling the energy-absorption capability of the center element include the pattern of the cell structure of the center element, shape of the unit cell, shape and dimension of the wall segments (Height Hw), shape and dimension of the connecting piece (Height Hc, thickness Tc), and whether the center element is glued to the underside of the outer panel or not, and so on. Three different examples are shown in FIG. 6B: in the first case, no connecting piece is provided in the junction region where two wall segments are joined; in the second case, solid cylindrical connecting pieces are provided in the junction region between two adjacent wall segments; in the third case, the cylindrical connecting pieces provided in the junction region between two adjacent wall segments are hollow. By comparison, it can be easily concluded that in case where no connecting pieces are provided in the junction region, collision resistance in the junction region will be the weakest one among the three cases. All the portions having low collision resistance will be the early broken ones when being impacted.

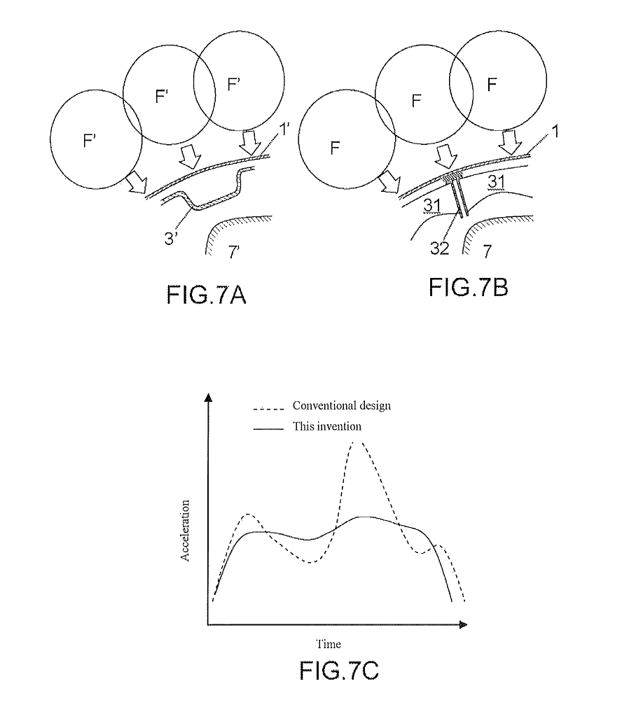

Referring to FIGS. 7A-7C, as compared with conventional engine hood for engine block 7′, the engine hood of the invention may have a better effect of absorbing impact energy. In conventional design, the inner panel 2′ is made of steel, and an engine hood with such an inner panel can not work well to absorb the impact energy of the flying head of the pedestrian. This is because steel ridges 3′ in the inner panel is so rigid that the impact force F′ applied to the ridges is almost entirely reflected to the head of the pedestrian, giving severe damage to the pedestrian. Contrarily, as shown in FIG. 7B, because the center element 3 of the inner panel 2 is made of plastic and has a design of cell structure comprising unit cells 30, the crushable center element 3 of the inner panel 2 of the engine hood of the invention enables uniform energy absorption in the event of being impacted. As shown in FIG. 7C, the acceleration curve of the head of the pedestrian being impacted against engine hood of the invention with impact force F is more smooth than that of the conventional engine hood. Within the limited space between the engine hood and the engine block 7 located below the engine hood, deformation of the engine hood will not bring any injury to the engine block 7 or its associated components in the engine room. From above it can be easily conceived that by changing or adjusting the parameters of the inner panel, for example, the cell pattern of the center element 3, geometry of wall segments 31, structure of the connecting pieces 32 and so on, possible injury to the pedestrian may be lowered down to a minimum appropriately.

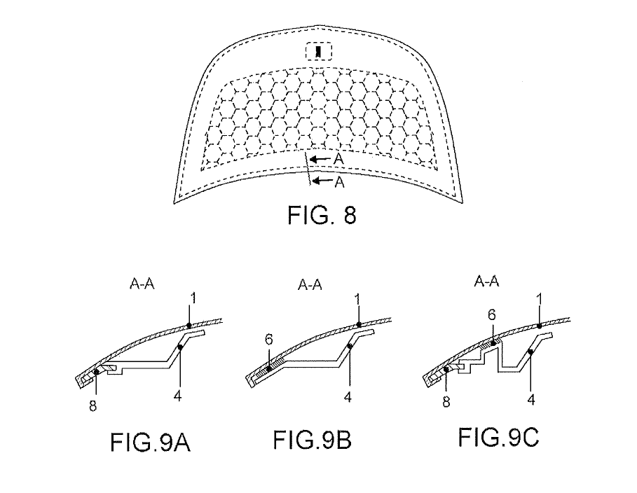

According to the invention, the outer panel and the inner panel are joined to each other at their peripheral portions. Their specific joining structure can be seen in FIGS. 9A-9C which are partial section views obtained from the line A-A at arbitrary positions along the joined periphery of the engine hood and viewed along the direction indicated by the arrows in FIG. 8. FIG. 9A shows that the outer frame 4 of the inner panel 2 is jointed to the outer panel 1 by an insert 8, for example, made of metal, wherein the periphery of the outer panel 1 folds downwardly and inwardly to form a recess for holding one end of the insert 8, and a further recess is provided on the outer edge of the outer frame 4 of the inner panel 2 for holding the other end of the inset 8. It can be envisaged that, the connection between the insert 8 and the periphery of the outer panel 1 can be made with mechanical locking structure, welding or any other ways known in the art. FIG. 9B shows the case where the outer edge of the outer frame 4 of the inner panel 2 is directly glued to the periphery of the outer panel 1 by adhesives 6. The periphery of the outer panel 1 folds downwardly to cover the outer circumferential surface of the outer frame. For reinforcing the strength of the joining area, adhesives 6 can be applied between the folding portion of the outer panel and the outer circumferential surface of the outer frame. It can be envisaged that, the periphery of the outer panel 1 may fold downwardly and inwardly to form a recess for holding the outer edge of the outer frame with adhesives 6 being applied between the recess and the outer edge of the outer frame. FIG. 9C shows the outer panel 1 is joined to the inner panel 2 through both the insert 8 and adhesives 6. Particularly, the outer frame 4 of the inner panel 2 is provided with a projection having a top surface adjacent to the underside of the outer panel. The top surface is an inclined surface with the same rate of slope as the underside surface of the outer panel I. The periphery of the outer panel and the periphery of the inner panel are joined together by the insert 8 and the top surface of the projection is glued to the underside of the panel 1 by adhesives 6, so that the connection theretween is further strengthened. In a particular embodiment, the insert 8 may be made of materials other than metal, for example, plastic.

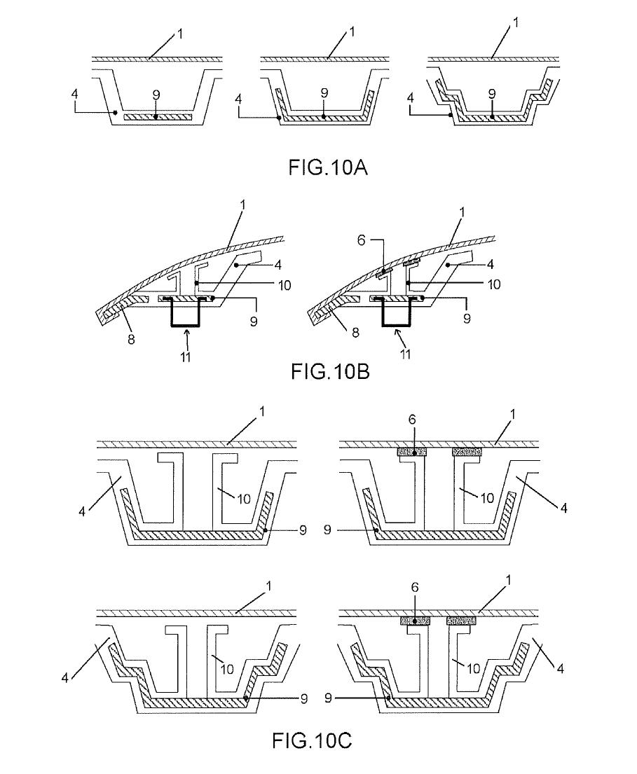

Accessories, for example, hinges and/or a lock striker, are to be installed on the engine hood. Strength and stiffness of area in vicinity of those accessories must be high enough so as to ensure normal opening or closing of the engine hood. In case of plastic inner panel of engine hood, since plastic itself is not hard enough to give desirable stiffness and strength, provision of reinforcing members in vicinity of those accessories may have to be considered. Referring to FIG. 10A, the reinforcing member is embodied as a metal insert plate 9 embedded in the outer frame 4 of the plastic inner panel 2. The metal insert plate 9 is configured to bend one or more times to form steps to be in conformity to the sectional configuration of the outer frame 4 of the inner panel 2. FIG. 10B shows the area in the vicinity of a locker attached to the inner panel 2. A striker 11 shown in this figure is directly connected to the metal insert plate 9 embedded in the inner panel. Support members 10, which are provided on the inner panel in the region corresponding to the striker 11, are extending from the inner panel 2 towards the outer panel 1. Seating surfaces are provided on ends of the support members that are close to the underside of the outer panel 1. These seating surfaces are configured to be parallel spaced from the underside of the outer panel. Optionally, adhesives 6 may be applied to the seating surfaces so as to glue the seating surfaces to the underside of the outer panel. FIG. 10C shows a combined application of the metal insert plate 9 and the support members 10. It will be appreciated that, for improving strength and stiffness of the inner panel, the skilled person could make any combination or modification to the above described embodiments in accordance with the practical needs of strength performance and design flexibility.

It will be apparent to those skilled in the art that various modifications and variations can be made to the disclosed engine hood without departing from the scope of the disclosure. Other embodiments of the engine hood will be apparent to those skilled in the art from consideration of the specification and practice disclosed herein. It is intended that the specification and examples be considered as exemplary only, with a true scope of the disclosure being indicated by the following claims and their equivalents.

1-18. (canceled)

19. An engine hood for an automobile, comprising:
an outer panel; and
an inner panel provided below the outer panel and connected to the outer panel, wherein the inner panel is provided with a center element of cell structure in the center portion thereof and an outer frame formed around the center element and disposed in the peripheral portion of the inner panel, each unit cell of the cell structure is bounded by a plurality of wall segments, the center element is made of plastic.

20. The engine hood according to claim 19, wherein slits or initial cracks are preformed on the wall segments.

21. The engine hood according to claim 19, wherein the wall segments are connected to each other by connecting pieces.

22. The engine hood according to claim 21, wherein slits or initial cracks are pre-formed in the region where the wall segments are connected to the connecting pieces.

23. The engine hood according to claim 19, wherein the center element is formed integrally or separately with respect to the outer frame.

24. The engine hood according to claim 19, wherein the inner panel is at least partially made of plastic.

25. The engine hood according to claim 19, wherein the wall segments are substantially perpendicular to the outer panel.

26. The engine hood according to claim 19, wherein the unit cells are in rectangular, rhombic or honeycomb-like shape.

27. The engine hood according to claim 21, wherein ends of the connecting pieces that are adjacent to the outer panel are configured to be attached to the underside of the outer panel.

28. The engine hood according to claim 27, wherein on the ends of the connecting pieces that are adjacent to the outer panel, flat seating surfaces are provided for application of adhesives thereon so as to attach to the underside of the outer panel.

29. The engine hood according to claim 19, wherein the periphery of the outer panel is joined to the outer edge of the outer frame by an insert.

30. The engine hood according to claim 29, wherein the periphery of the outer panel folds downwardly and inwardly to form a recess for holding one end of the insert, and the outer edge of the outer frame is provided with a corresponding recess for holding the other end of the insert.

31. The engine hood according to claim 19, wherein a reinforcing member is provided on the outer frame in a region where accessories are to be attached.

32. The engine hood according to claim 31, wherein the reinforcing member comprises support members extending from the inner panel towards the underside of the outer panel.

33. The engine hood according to claim 31, wherein the reinforcing member comprises metal insert plates embedded in the outer frame of the inner panel.

34. The engine hood according to claim 33, wherein the metal insert plates are bended one or plural times to form steps.

35. An automobile comprising an engine hood according to claim 19.
